(19) United States
(12) Patent Application Publication
(10) Pub. No.: US 2016/0171360 A1
(43) Pub. Date: Jun. 16, 2016

(54) METHOD FOR RETRIEVING INFORMATION REGARDING THE OPERATION, MAINTENANCE AND/OR ASSEMBLY OF A MACHINE

(71) Applicant: J.W. Weisser Sohne GmbH & Co. KG, St. Georgen (DE)

(72) Inventor: Thorsten Rettich, Konigsfeld (DE)

(73) Assignee: J.W. Weisser Sohne GmbH & Co. KG, St. Georgen (DE)

(21) Appl. No.: 14/908,013

(22) PCT Filed: Aug. 21, 2014
(86) PCT No.: PCT/EP2014/067849

§ 371 Date: Jan. 27, 2016

(30) Foreign Application Priority Data
Aug. 22, 2013 (DE) 102013014510.4

(51) Int. Cl. G06K 19/06; G06F 17/30

(52) U.S. Cl. CPC G06K 19/06037; G06F 17/30477

(57) ABSTRACT

In a machine (1) according to the invention, machine-readable codes (2, 3, 4) that can be externally read out are attached to said machine and read out using a reader (7), each machine-readable code (2, 3, 4) being converted into at least one piece of information (15) concerning the operating instructions, maintenance instructions and/or assembly instructions using an electronic database (11, 12), this information subsequently being displayed on an optical receiving unit (8) of the reader (7).

### BACKGROUND

The invention relates to a method for the operation, maintenance and/or assembly of a machine, in particular a machine tool, wherein items of information concerning operation instructions, maintenance instructions and/or assembly instructions are kept available on the machine.

It has become customary to attach such items of information as text on plates on the machine. An operator reads this information and chooses the associated measures in documentation. In the case of present-day complex machines, however, such documentation is very extensive and has to be kept separate from the processing machine tools for reasons of space. Therefore, during maintenance measures, undesired time delays arise until the items of information concerning maintenance and the like are actually present. This can result in production outages of unwanted length. Furthermore, there is the risk of the associated items of information concerning operation instructions, maintenance instructions and/or assembly instructions not being chosen from the documentation and therefore being complied with only to an inadequate extent.

The invention furthermore relates to a machine, in particular a machine tool.

The invention is concerned with simplifying and thus shortening the operation, maintenance and/or assembly process for a machine.

### SUMMARY

In order to achieve this object, one or more features according to the invention are provided. In particular, therefore, in the case of a method of the type described in the introduction, the invention proposes that at least one machine-readable code is attached to the machine, that the machine-readable code is read out by a user using a reader, and that at least one associated item of information concerning operation instructions, maintenance instructions and/or assembly instructions is automatically selected from an electronic database and displayed on a display unit. What is advantageous here is that it is possible to dispense with keeping paper documentation available. What is furthermore advantageous is that the user, on the basis of the read-out information of the machine-readable code, can be led automatically to the relevant place in documentation kept available electronically. An acceptance of complex documentation can thus also be increased. The associated operation, maintenance and/or assembly process can thus be shortened.

A multiplicity of different formats are known for machine-readable codes. By way of example, the machine-readable code can be a 1D code, 2D code or 3D code. In the case of a 1D code, the information to be coded is applied along a single axis; in the case of a 2D code, said information is applied along two axes, thus resulting overall in an areal arrangement; and in the case of a 3D code, an item of color information or an item of depth information, for example, is used as a further dimension for the coding of the items of information. What is advantageous here is that standardized methods for reading out the machine-readable code can be used. It is particularly expedient if the machine-readable code is a barcode, a QR code or a data matrix code (DMC).

In this case or generally, it can be provided that the machine-readable code is read out optically. What is advantageous here is that the machine-readable code can also be optically perceived by a user, with the result that it is immediately possible to recognize that such a machine-readable code is present and where it is to be read out. Alternatively or additionally, it can be provided that the machine-readable code is read out via radio, for example by means of RFID (Radio-Frequency Identification, identification with the aid of electromagnetic waves) technology. What is advantageous here is that an RFID reader does not have to be directed directly at the machine-readable code, rather it suffices to arrange or hold the reader in proximity to the machine-readable code, here an RFID tag.

In one configuration of the invention, it can be provided that the at least one item of information concerning operation instructions, maintenance instructions and/or assembly instructions contains at least one voice-independent graphical information item. What is advantageous here is that translations of the documentation, for example for use of the documentation or the machine abroad or in foreign-language environments, can be dispensed with.

In one configuration of the invention, it can be provided that the at least one item of information concerning operation instructions, maintenance instructions and/or assembly instructions is stored as a multimedia file. What is advantageous here is that it is possible to represent not only written items of information in the form of texts, but also items of information in the form of photographs, graphics, animations, audio and/or video or combinations of these types of information or types of media. What is advantageous here, in particular, is that motion sequences or action sequences can be represented in a manner that can be grasped intuitively. These animations or videos can for example also contain 3D models of parts of the machine and the function sequences thereof.

In one configuration of the invention, it can be provided that an image of the machine is used to designate a part of the machine to which the at least one item of information concerning operation instructions, maintenance instructions and/or assembly instructions relates. What is advantageous here is that the user, without profound knowledge about the internal function sequence in the machine, can directly comprehend to what part of the machine the displayed at least one item of information concerning operation instructions, maintenance instructions and/or assembly instructions relates. By way of example, the part of the machine can be a hydraulic unit, a tool carrier, a cooling apparatus, a switchgear cabinet, a drive unit or the like.

In this case or generally, it can be provided that an image, for example the image already mentioned, is recorded by the user in temporal proximity to the reading out of the machine-readable code. What is advantageous here is that a current image of the actual conditions at the machine can be used for displaying the item of information concerning operation instructions, maintenance instructions and/or assembly instructions, such that a user can establish a direct relation between the items of information that are output and the machine. It is particularly expedient if said image is recorded simultaneously with the reading out of the machine-readable code. What is advantageous here is that between the point in time of reading out the machine-readable code and the point in time of recording an image of the machine, no changes are possible on the machine, such that a current image can be used.

In this case or generally, it can be provided that a position of the machine-readable code is determined automatically in an image, for example the image already mentioned. What is advantageous here is that a reference point is provided with which the items of information that are output can be related to parts of the machine that are localized in relation to said reference point. It is particularly expedient if said image was recorded by the machine, since a true-to-life image of the machine can thus be used.

In one configuration of the invention, it can be provided that the at least one item of information concerning operation instructions, maintenance instructions and/or assembly instructions is brought to registration with the or a recorded image. What is advantageous here is that the item of information concerning operation instructions, maintenance instructions and/or assembly instructions can be provided with indications of parts of the machine which can be brought into association directly with the really recorded parts by means of the registration. This considerably facilitates the explanation of items of information concerning operation instructions, maintenance instructions and/or assembly instructions for an untrained operator.

In one configuration of the invention, it can be provided that the at least one item of information concerning operation instructions, maintenance instructions and/or assembly instructions contains a representation of a part of the machine that is not visible externally. What is advantageous here is that a user can obtain items of information about substantive matter and sequences within the machine, without a cover having to be demounted beforehand. On the basis of the items of information given, the user can therefore subsequently decide whether the machine has to be opened, for example. It is particularly expedient if the representation is effected as a 3D model. It is thus possible to provide a realistic image of the relative arrangements of the parts with respect to one another and of the interaction of the parts.

In order to achieve the stated object, according to the invention, in the case of a machine, in particular in the case of a machine tool, it is provided that the machine has at least one machine-readable code that can be read out externally, that a reader is designed for reading out the machine-readable code, that the reader has access to a database having items of information concerning operation instructions, maintenance instructions and/or assembly instructions assigned to machine-readable codes, and that the reader is designed for selecting and displaying by means of a display unit at least one item of information concerning operation instructions, maintenance instructions and/or assembly instructions assigned to a machine-readable code that has been read out. What is advantageous here is that it is possible to provide items of information concerning operation instructions, maintenance instructions and/or assembly instructions that can be taken as a basis on the machine and that can be output or displayed without complex searching through extensive documentation by virtue of the fact that a user reads out the corresponding machine-readable code on the machine using the reader. It is particularly expedient if the individual parts of the machine are provided in each case with an associated machine-readable code, such that a user can retrieve in a targeted manner an item of information concerning operation instructions, maintenance instructions and/or assembly instructions with respect to a part of the machine that is of interest to said user.

In one configuration of the invention, it can be provided that the reader is fixed to a mount of the machine. What is advantageous here is that the reader can be kept available continuously on the machine for the purpose of reading out the machine-readable code and for the purpose of displaying the assigned item of information concerning operation instructions, maintenance instructions and/or assembly instructions. It is particularly expedient if the reader is releasably fixed to the mount. What is advantageous here is that a user can take the reader to examine different aspects or parts of the machine at which individually assigned machine-readable codes are present.

In one configuration of the invention, it can be provided that the display unit is integrated into the reader. What is advantageous here is that a compact aid with regard to operation, maintenance and/or assembly is made available. Alternatively, it can be provided that the display unit is fixed to the machine separately from the reader, for example.

In one configuration of the invention, it can be provided that the database is provided in the reader. What is advantageous here is that the aid already mentioned can be used autonomously.

Alternatively or additionally, it can be provided that the reader is connectable to the database via a data connection. The data connection can be effected by means of WLAN. What is advantageous here is that the database can be kept up to date externally. It is particularly expedient if the data connection is effected via the Internet. Existing technologies for providing and updating data of a database can thus be used.

In one configuration of the invention, it can be provided that the machine-readable code is provided on a marker. What is advantageous here is that the code can be attached to the outer side of the machine in a simple manner, for example as an adhesive label. It is particularly expedient here if the marker is attached to an externally visible location of the machine. The marker is thus immediately recognizable and identifiable externally and what can thus be achieved is that the marker can be read out without further intermediate steps.

It is particularly expedient here if the machine-readable code is provided on a marker that can be read out optically, for example as a 1D, 2D or 3D code. What is advantageous here is that simple read-out methods can be used, in particular conventional cameras with downstream image processing. Alternatively or additionally, it can be provided that the machine-readable code is provided on a marker that can be read out using RFID technology. The machine-readable code can thus be provided as RFID tech. What is advantageous here is that no direct visual contact with the marker is required during read-out.

In one configuration of the invention, it can be provided that an optical receiving unit is present, wherein the reader is designed for displaying an image recorded by the optical receiving unit with the at least one item of information concerning operation instructions, maintenance instructions and/or assembly instructions. The optical receiving unit can be a camera, for example. What is advantageous here is that machine-readable codes that can be read out optically can be read out directly. It is particularly expedient if the optical receiving unit is integrated into the reader in order to provide a compact handheld device.

Alternatively or additionally, it can be provided that the reader is embodied as an RFID reader. What is advantageous here is that RFID tags with machine-readable codes can be read out. It is particularly expedient if the reader has both an optical receiving unit and an RFID reader. A universally useable reader is provided in this way.

In one configuration of the invention, it can be provided that the reader is designed for determining an image position of the machine-readable codes on a recorded image. What is advantageous here is that an item of information concerning operation instructions, maintenance instructions and/or assembly instructions can be related to a part of the machine which is imaged in the image at a specific position relative to the machine-readable code. The machine-readable code can thus additionally be used as a reference point for location indications in the item of information concerning operation instructions, maintenance instructions and/or assembly instructions.

In one configuration of the invention, it can be provided that the reader is designed for registering an image recorded by the optical receiving unit with the item of information concerning operation instructions, maintenance instructions and/or assembly instructions. In this case, registration is understood to mean an image shift or image rotation or other image processing by which image contents associated with one another are brought to correspondence or even congruence with one another. What is advantageous here is that an item of information concerning operation instructions, maintenance instructions and/or assembly instructions which is related to a part of a machine can be brought into association with an actual imaging of said part of the machine. This makes it easier for the user to find the associated part to which the information relates.

In one configuration of the invention, it can be provided that the reader is a tablet or a smartphone or a smartwatch or smartglasses or some other intelligent reading and/or visual aid or some other mobile data processing unit. What is advantageous here is that it is possible to use commercially available, multimedia-enabled readers with an integrated display, the typically built-in optical receiving unit of which can be used as a reader for a code that can be read out optically.

Synergistic effects arise if the machine according to the invention are embodied means for carrying out a method according to the invention, in particular as described above and/or as claimed in any of the claims directed to a method. What can thus be achieved is that the method according to the invention can be carried out on a machine.

It is particularly expedient if the machine according to the invention is a machine tool, for example a turning machining machine, a grinding machine, a milling machine or any other machines for material-removing and/or non-material-removing machining of workpieces, and/or if the method according to the invention is performed by such a machine. Alternatively, the machine can also be embodied as some other workpiece machining and/or workpiece processing machine, for example for placement, for mounting, for connecting such as welding or adhesive bonding.

The invention will now be described in greater detail on the basis of an exemplary embodiment, but is not restricted to this exemplary embodiment. Further exemplary embodiments arise through combination of the features of individual or a plurality of claims among one another and/or with individual or a plurality of features of the exemplary embodiment.

### BRIEF DESCRIPTION OF THE DRAWINGS

In a greatly simplified single illustration:

FIG. 1 shows a machine according to the invention with a reader for elucidating the method according to the invention.

### DETAILED DESCRIPTION OF THE PREFERRED EMBODIMENTS

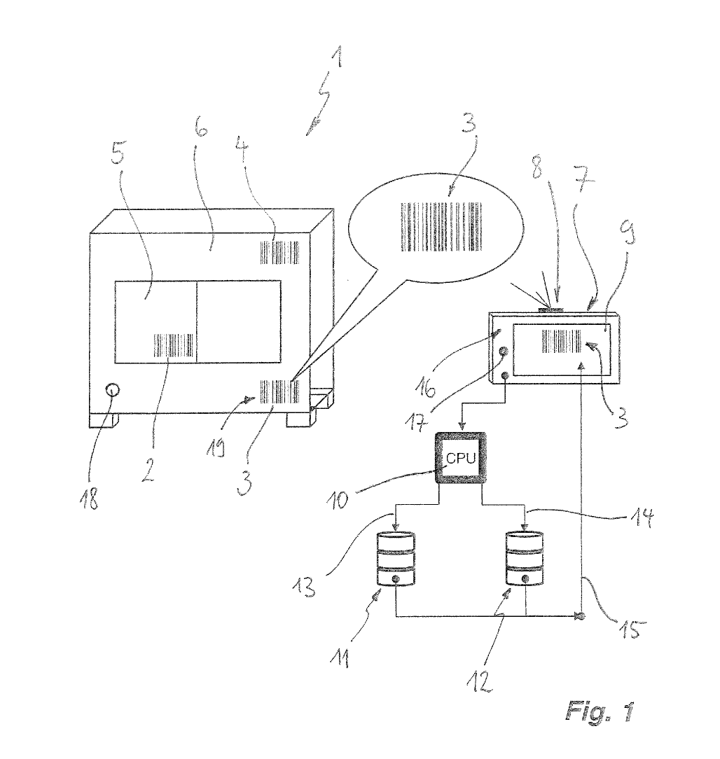

FIG. 1 shows highly schematically a machine according to the invention, said machine being designated by 1 as a whole and being shown here as a machine tool, for the purpose of elucidating the invention. Details of the machine which are not absolutely necessary for elucidating the invention have been omitted in order to simplify the illustration. In this case, the machine 1 can be for example a turning machining machine, a grinding machine, a milling machine or any other machine for material-removing and/or non-material-removing machining of workpieces. In further exemplary embodiments, the machine can be embodied as a handling unit, forming machine, sorting machine and/or automatic placement machine or as some other workpiece machining and/or workpiece processing machine.

Machine-readable codes 2, 3 and 4 are attached to the machine 1 on the outer side. In this case, the machine-readable code 2 is arranged on a housing door 5, while the machine-readable codes 3 and 4 are applied on a housing 6 of the machine. The position and number of machine-readable codes 2, 3 and 4 serve merely as an example and can deviate from the situation shown in further exemplary embodiments.

The machine 1 according to the invention comprises a reader 7 having an optical receiving unit 8.

By the use of the optical receiving unit 8, the machine-readable codes 2, 3, 4 can be read out and can be displayed on a display unit 9, here a display.

The reader 7 is designed for image processing, such that the machine-readable code 2, 3, 4 can be processed and evaluated.

By way of example, the optical receiving unit 8 can be directed at the machine-readable code 3 on the housing 6 in order to read out said machine-readable code 3.

The image processing of the recorded machine-readable code 2, 3, 4 is effected for example in a microprocessor 10 of the reader 7. The microprocessor 10 can be provided in the reader 7 or an external computer.

Items of information concerning operation instructions, maintenance instructions and/or assembly instructions which are assigned in each case to possible contents of the machine-readable codes 2, 3, 4 are kept available in an external database 11 or an internal database 12. These items of information concerning operation instructions, maintenance instructions and/or assembly instructions can contain for example 3D data, parts lists, step-by-step instructions or other important items of information and/or instructions.

Via an external data connection 13, for example via the Internet, or an internal data connection 14 to the internal database 12 in the reader 7, the microprocessor 10 accesses the respective database 11, 12 in order to automatically select the respectively associated item of information concerning operation instructions, maintenance instructions and/or assembly instructions with respect to the machine-readable code 3 read out.

The selected item of information 15 concerning operation instructions, maintenance instructions and/or assembly instructions is subsequently forwarded—once again by the microprocessor 10 in the example—to the display unit 9, where it is displayed.

In the exemplary embodiment shown, the machine-readable code 2, 3, 4 is realized as a 1D code, here as a barcode. In further exemplary embodiments, other coding methods, for example as a 2D code or as a 3D code, are realized.

Instead of the optical receiving unit 8 or in addition thereto, the reader 7 can comprise an RFID reader 16 in order to read out machine-readable codes attached as an RFID tag to the machine 1.

The selected item of information 15 concerning operation instructions, maintenance instructions and/or assembly instructions contains graphical information items stored in the form of a multimedia file. These information items, for example images, graphics, videos, lists, texts, can thus be displayed on the display unit 9.

Using operating elements 17, a user can display or play back anew the selected item of information 15 concerning operation instructions, maintenance instructions and/or assembly instructions.

If the item of information 15 concerning operation instructions, maintenance instructions and/or assembly instructions contains images of the machine 1 or images of parts of the machine 1, then these images can be brought to registration with an image actually recorded by the machine 1 by means of the optical receiving unit 8. This is done using means and methods of image processing that are known per se.

For this purpose, the microprocessor 10 determines the position of the recorded machine-readable code 3 in the recorded image of the machine 1 and assigns the corresponding parts of the selected item of information 15 concerning operation instructions, maintenance instructions and/or assembly instructions to the parts of the recorded image of the machine 1 which correspond in terms of contents.

If, by way of example, the machine-readable code 2 on the housing door 5 of the machine 1 is read out instead of the machine-readable code 3, then the microprocessor 10 recognizes that a machine-readable code 2 on a part of the machine 1 that can be opened is involved.

The item of information 15 concerning operation instructions, maintenance instructions and/or assembly instructions can therefore contain image information concerning parts of the machine 1 which are situated behind the housing door 5. In this case, the item of information concerning operation instructions, maintenance instructions and/or assembly instructions contains a representation of at least one part of the machine 1 that is not visible externally with the housing door 5 not open. This representation can depict the part as a 3D model on the display unit 9, for example.

In the exemplary embodiment, the reader 7 is shown as a smartphone or as an Internet-enabled digital camera. In further exemplary embodiments, other readers 7 having an optical receiving unit 8 and/or having an RFID reader 16 are present, which, via a display unit 9, are designed for displaying at least the selected item of information 15 concerning operation instructions, maintenance instructions and/or assembly instructions and preferably additionally the machine-readable code 2, 3, 4 that has been read out.

In order to keep the reader 7 ready for use, a mount 18 for releasably fixing the reader 7 to the machine is embodied on the machine 1. In this way, an operator can use the reader 7 as necessary to select and display the content respectively associated with the machine-readable codes 2, 3, 4 in the form of an item of information 15 concerning operation instructions, maintenance instructions and/or assembly instructions.

In the case of the machine 1, it is proposed to attach machine-readable codes 2, 3, 4 that can be read out externally and to read them out using a reader 7, wherein the machine-readable code 2, 3, 4 respectively read out is converted, with the aid of an electronic database 11, 12, into at least one item of information 15 concerning operation instructions, maintenance instructions and/or assembly instructions which is subsequently displayed on an optical receiving unit 8 of the reader 7.

1. A method for at least one of operation, maintenance or assembly of a machine (1) comprising keeping items of information (15) concerning at least one of operation instructions, maintenance instructions or assembly instructions available on the machine (1) by attaching at least one machine-readable code (2, 3, 4) to the machine (1), reading the machine-readable code (2, 3, 4) using a reader (7), and automatically selecting at least one associated one of the items of information (15) concerning the at least one of the operation instructions, the maintenance instructions or the assembly instructions from an electronic database (11, 12) and displaying the at least one associated one of the items of information on a display unit (9).

2. The method as claimed in claim 1, wherein the machine-readable code (2, 3, 4) is a 1D code, 2D code or 3D code, or the machine-readable code is read out optically or via an RFID.

3. The method as claimed in claim 1, wherein or the at least one item of information (15) concerning the at least one of the operation instructions, the maintenance instructions or the assembly instructions contains at least one voice-independent graphical information item.

4. The method as claimed in claim 1, further comprising an image of the machine (1) to designate a part of the machine (1) to which the at least one item of information (15) concerning the at least one of the operation instructions, the maintenance instructions or the assembly instructions relates.

5. The method as claimed in claim 1, further comprising a user recording an image is in temporal proximity to the reading of the machine-readable code (2, 3, 4).

6. The method as claimed in claim 1, wherein the at least one item of information (15) concerning the at least one of the operation instructions, the maintenance instructions or the assembly instructions is brought to registration with a recorded image, or the at least one item of information (15) concerning the at least one of the operation instructions, the maintenance instructions or the assembly instructions contains a representation of a part of the machine (1) that is not visible externally, or both.

7. A machine (1) comprising at least one machine-readable code (2, 3, 4) that is readable externally, a reader (7) configured for reading out the machine-readable code (2, 3, 4), a database (11, 12) having items of information (15) concerning at least one of operation instructions, maintenance instructions or assembly instructions assigned to the machine-readable codes (2, 3, 4) that is accessible by the reader, and a display unit (9) upon which the reader displays the at least one item of information (15) concerning the at least one of the operation instructions, the maintenance instructions or the assembly instructions (15) assigned to the machine-readable code (2, 3, 4) that has been read out.

8. The machine (1) as claimed in claim 7, wherein the reader (7) is releasably fixed to a mount (18) of the machine (1).

9. The machine (1) as claimed in claim 7, wherein the database (11, 12) is provided in the reader (7).

10. The machine (1) as claimed in claim 7, wherein the machine-readable code (2, 3, 4) is provided on a marker (19) that is readable optically or using RFID technology, on an externally visible location of the machine (1).

11. The machine (1) as claimed in claim 7, further comprising an optical receiving unit (8) integrated into the reader (7), and the reader (7) is configured to an image recorded by the optical receiving unit (8) with the at least one item of information (15) concerning that at least one of the operation instructions, the maintenance instructions or the assembly instructions.

12. The machine (1) as claimed in claim 7, wherein the reader (7) is configured to determine an image position of the machine-readable code (2, 3, 4) in a recorded image.

13. The machine (1) as claimed in claim 7, wherein the reader (7) is a tablet PC or a smartphone or a smartwatch or smartglasses or an intelligent reading or visual aid or a mobile data processing unit.

14. The method as claimed in claim 2, wherein the machine readable code is a barcode, a QR code, or a data matrix code.

15. The method as claimed in claim 1, wherein that the at least one item of information (15) concerning the at least one of the operation instructions, the maintenance instructions or the assembly instructions is stored as a multimedia file.

16. The method as claimed in claim 5, further comprising automatically determining a position of the machine-readable code (2, 3, 4) in the recorded image.

17. The machine as claimed in claim 7, wherein the display unit (9) is integrated into the reader.

18. The machine as claimed in claim 7, wherein the reader (7) is connectable to the database (11, 12) via a data connection (13, 14).

19. The machine as claimed in claim 7, wherein the reader (7) comprises an RFID reader (16).

20. The machine as claimed in claim 7, wherein the reader (7) is configured to register an image recorded by the optical receiving unit (8) with the item of information (15) concerning the at least one of the operation instructions, the maintenance instructions or the assembly instructions.
